(19) United States
(12) Patent Application Publication
(10) Pub. No.: US 2022/0365466 A1
(43) Pub. Date: Nov. 17, 2022

(54) FIXING TONER IMAGE USING GLOSS APPLYING DEVICE

(71) Applicant: HEWLETT-PACKARD DEVELOPMENT COMPANY, L.P., Spring, TX (US)

(72) Inventors: Satoshi OHWADA, Yokohama, Kanagawa (JP); Hiroyuki SATO, Yokohama, Kanagawa (JP)

(21) Appl. No.: 17/764,330

(22) PCT Filed: Sep. 22, 2020
(86) PCT No.: PCT/US2020/051949

§ 371 Date: Mar. 28, 2022

(30) Foreign Application Priority Data
Oct. 11, 2019 (JP) 2019-187302

(51) Int. Cl. G03G 15/20; G03G 15/00

(52) U.S. Cl. CPC G03G 15/2032; G03G 15/6585

(57) ABSTRACT

An image forming apparatus includes a transfer device to transfer an unfixed toner image to a print medium, a fixing device located along a conveyance path of the print medium, and a gloss applying device. The unfixed toner image includes clear toner that is associated with a gloss image to be formed. The gloss applying device receives the print medium including the unfixed toner image, to fix the unfixed toner image to the print medium by applying heat and pressure, and to cool the heated toner image to form the gloss image.

### BACKGROUND

Image forming apparatuses may include, in addition to a fixing device, a gloss applying device to form a gloss image.

### BRIEF DESCRIPTION OF DRAWINGS

FIG. 1 is a schematic diagram of an example image forming apparatus.

FIG. 2A is a schematic diagram illustrating an example release/contact mechanism for a fixing roller and a pressure roller, according to an example state.

FIG. 2B is a schematic diagram illustrating the example release/contact mechanism of FIG. 2A, according to another example state.

FIG. 3 is a schematic diagram of an example gloss applying device.

FIG. 4 is a schematic diagram of the example gloss applying device.

FIG. 5 is a schematic diagram of the example image forming apparatus, illustrating an example operational state.

FIG. 6 is a schematic diagram of the example image forming apparatus, illustrating an example operational state.

FIG. 7 is a schematic diagram of another example image forming apparatus.

FIG. 8 is a schematic diagram of the example image forming apparatus, illustrating an example operational state.

FIG. 9 is a schematic diagram of the example image forming apparatus, illustrating an example operational state.

FIG. 10 is a flow chart illustrating an example method of manufacturing an example image forming apparatus.

### DETAILED DESCRIPTION

In the following description, with reference to the drawings, the same reference numbers are assigned to the same components or to similar components having the same function, and overlapping description is omitted.

Image forming apparatuses may form a toner image by use of clear toner to form a gloss image. Some image forming apparatuses include a fixing device that cause a paper jam when fixing a toner image that includes clear toner. Clear toner may have a higher adhesiveness when fused by heat as compared to color toner, which may cause the paper to wind around a fixing roller, inhibiting the fixing roller from releasing the paper. In addition, when the clear toner has an adhesiveness at the same or similar level as an adhesiveness of other toner, or when no clear toner is used (e.g., color toner is used exclusively), the paper may jam or curl in the fixing device depending on the deposition amount of toner or conditions such as an ambient temperature.

An example image forming apparatus includes a gloss applying device (or gloss treatment device) to fix a toner image. The example image forming apparatus includes: a transfer device to transfer a toner image including clear toner to a print medium when a gloss image is to be formed, a fixing device to form a non-gloss image, and the gloss applying device. When the gloss image is to be formed, the gloss applying device receives the print medium from the transfer device through the fixing device which is in a non-operating state, fixes the toner image to the print medium by applying heat and pressure, and cools the toner image. The fixing device may include a conveying device such as a fixing belt or a fixing roller, and a pressure device such as a pressure belt or a pressure roller. The conveying device and the pressure device can be separated (spaced apart) from each other, or in contact with each other. When the gloss image is to be formed, the conveying device (e.g., the fixing belt or the fixing roller) and the pressure device (e.g., the pressure belt or the pressure roller) may be separated from each other, and a first conveyance path may be formed between the conveying device and the pressure device to convey the print medium from the transfer device to the gloss applying device. The first conveyance path may be configured so as not to cause a surface of the print medium having the toner image to be in contact with any component of the image forming apparatus when the print medium is conveyed from the transfer device to the gloss applying device. A length of the first conveyance path from the transfer device to the gloss applying device may be shorter than a length of the print medium in a conveyance direction.

Another example image forming apparatus using a gloss applying device to fix a toner image includes: a transfer device to transfer a toner image including clear toner to a print medium when a gloss image is to be formed, a fixing device to form a non-gloss image, and the gloss applying device. When the gloss image is to be formed, the gloss applying device receives the print medium which has travelled from the transfer device without passing through the fixing device, fixes the toner image to the print medium by applying heat and pressure, and cools the toner image. The image forming apparatus may include: a second conveyance path to convey the print medium which has travelled from the transfer device to the gloss applying device without passing through the fixing device; and a conveyance path switching device. When the gloss image is to be formed, the conveyance path switching device directs the print medium with the toner image to travel from the transfer device to the second conveyance path. The second conveyance path may be configured to prevent or inhibit a surface (an image surface) of the print medium having the toner image from contacting any component of the image forming apparatus when the print medium is conveyed from the transfer device to the gloss applying device. A length of the second conveyance path from the transfer device to the gloss applying device may be shorter than a length of the print medium in a conveyance direction.

In some examples, when the non-gloss image is to be formed, the transfer device may transfer a toner image including no clear toner (a toner image without clear toner) to the print medium; and the fixing device may receive the print medium from the transfer device and fix the toner image to the print medium by applying heat and pressure. The print medium to which the toner image without clear toner was fixed, may be discharged from the image forming apparatus without being conveyed through the gloss applying device. The print medium to which the toner image without clear toner was fixed, may be discharged from the image forming apparatus through the gloss applying device under a predetermined condition, to correct a curl formed in the print medium by re-melting and cooling the toner image. The predetermined condition may include at least one of conditions about a deposition amount of toner per unit area on the print medium, a thickness of the print medium, an ambient temperature of the image forming apparatus, an ambient humidity of the image forming apparatus, and a width of a head margin in the print medium. The gloss applying device may include: a heating roller including a heater; a suspension roller; an endless belt stretched between the heating roller and the suspension roller to move circularly; and a pressure roller to press the print medium against the heating roller via the endless belt to fix the toner image through heat and pressure. The gloss applying device may cool the toner image while the toner image is closely in contact (e.g., in surface contact) with an outer circumferential surface of the endless belt moving from the heating roller to the suspension roller. The gloss applying device may include a cooling device located inside the endless belt.

In some examples, an image forming apparatus uses a gloss applying device to fix a toner image. The image forming apparatus includes: a transfer device to transfer a toner image to a print medium, a fixing device to fuse and fix an unfixed toner image by applying heat and pressure, the gloss applying device, a first switching device and a second switching device. The gloss applying device fuses and fixes the unfixed toner image or a fixed toner image by applying heat and pressure, cools the toner image while the toner image is closely attached to (e.g., in surface contact with) a belt, and releases the print medium from the belt. The first switching device switches between operational modes depending on whether or not the unfixed toner image is to be fixed by the fixing device. The second switching device to switches between operational modes depending on whether or not the unfixed toner image or the fixed toner image is to be fixed by the gloss applying device. The first switching device may include, in some examples, a release/contact mechanism to cause a fixing roller (or a fixing belt) and a pressure roller (or a pressure belt) to be separated from (apart from) or in contact with each other in the fixing device. In some examples, the first switching device may include a movable guide provided upstream of the fixing device to switch an advancing direction of the print medium between a first direction toward the fixing device and a second direction toward a bypass path. The second switching device may include a release/contact mechanism to cause a heating roller and a pressure roller to be separated from (apart from) or in contact with each other in the gloss applying device. In some examples, the second switching device may include a movable guide provided upstream of the gloss applying device to switch an advancing direction of the print medium between a first advancing direction toward the gloss applying device and a second advancing direction toward a bypass path.

An example method of manufacturing an image forming apparatus that uses a gloss applying device to fix a toner image, may include: providing a transfer device to transfer a toner image including clear toner to a print medium when a gloss image is to be formed; providing a fixing device to form a non-gloss image; and providing a gloss applying device to, when the gloss image is to be formed, receive the print medium having passed through the fixing device or having bypassed the fixing device which is in a non-operating state, fix the toner image to the print medium by applying heat and pressure, and cool the toner image.

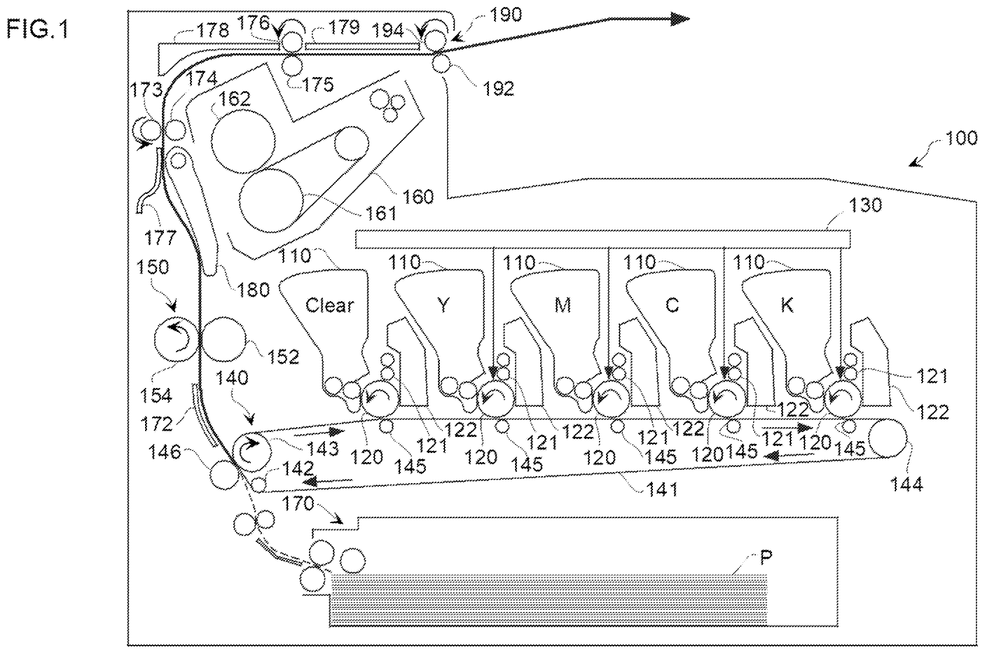

FIG. 1 illustrates an example image forming apparatus 100. The image forming apparatus 100 includes for each of four colors of toner (yellow, magenta, cyan and black) and for a clear toner, a developing device 110, a photosensitive drum 120, a charging roller 121 and a cleaning unit (cleaning device) 122. Each developing device 110 stores toner of a corresponding color. The image forming apparatus 100 includes an exposure unit (exposure device) 130, a transfer device 140, a fixing device 150, a gloss applying device 160, a print medium conveying unit (print medium conveying device) 170, a conveyance path switching device 180, and a discharge device 190. The conveyance path switching device 180 includes a guide plate that is rotatable about a rotational shaft, for example by a driving device such as a solenoid. The transfer device 140 includes an intermediate transfer belt 141, suspension rollers 142, 143, 144 suspending or supporting the intermediate transfer belt 141 in a circularly movable manner, five primary transfer rollers 145 corresponding to the respective five photosensitive drums 120, and a secondary transfer roller 146 that rotates by following the movement of the intermediate transfer roller 141 while pressing a print medium P supplied from the print medium conveying unit 170 against the intermediate transfer belt 141. The suspension roller 143 is configured as a driving roller to circularly move the intermediate transfer belt 141 in a direction indicated by an arrow. The discharge device 190 includes a pair of discharge rollers 192, 194.

The fixing device 150 includes a fixing roller (conveying device) 152 and a pressure roller (pressure device) 154 that can be separated from (spaced apart from) or in contact with each other. The fixing roller 152 includes a heater such as a halogen lamp therein. In other examples, the fixing roller 152 may be a fixing belt 152. The pressure roller 154 can be rotated by a driving device. In some examples, the pressure roller 154 may be a pressure belt 154. A release/contact mechanism (movable mechanism) between the fixing roller 152 and the pressure roller 154 may be the same as or similar to a release/contact mechanism used to prevent adhesion between the fixing roller 152 and the pressure roller 154 when the image forming apparatus is not used, or may be provided by other suitable mechanisms depending on examples.

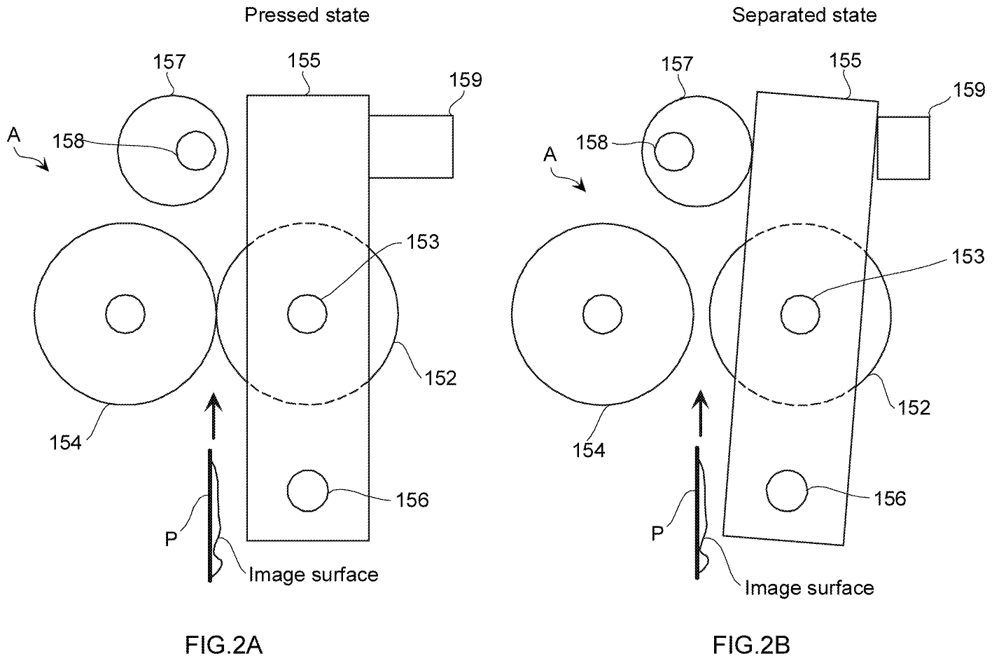

FIGS. 2A and 2B show an example release/contact mechanism A between the fixing roller 152 and the pressure roller 154, that is based on a cam-follower mechanism. The example release/contact mechanism A includes a long and narrow movable support member 155 that supports both ends of a rotational shaft 153 of the fixing roller 152, a cam 157 having an eccentric shaft 158, and a spring 159. When the print medium P is allowed to pass through the fixing device 150 without pressing, the cam 157 is rotated to a position shown in FIG. 2B. Consequently, the movable support member 155 is rotated to a position shown in FIG. 2B about a rotational shaft 156 while compressing the spring 159, so as to separate the fixing roller 152 from the pressure roller 154. When the print medium P is to be pressed, the cam 157 is rotated to a position shown in FIG. 2A. Consequently, the movable support member 155 is returned to a position shown in FIG. 2A about the rotational shaft 156 by the spring 159, thereby bringing the fixing roller 152 into contact with the pressure roller 154. In the example of FIGS. 2A and 2B, the fixing roller 152 and the pressure roller 154 are separated from (spaced apart) or in contact with each other by moving the fixing roller 152. In other examples, moving of the pressure roller 154 may enable the fixing roller 152 and the pressure roller 154 to be separated from (moved apart) or in contact with each other. Depending on examples, the release/contact mechanism between the fixing roller 152 and the pressure roller 154 may be provided by any suitable mechanism that causes the fixing roller 152 and the pressure roller 154 to be separated from (spaced apart) or in contact with each other and may or may not include a cam-follower mechanism such as the one shown in FIGS. 2A and 2B.

FIG. 1 shows an operation of the image forming apparatus 100 when a non-gloss image (also referred to as “ordinary image” or “standard image”) is to be formed. When a non-gloss image is to be formed, the image forming apparatus 100 first uses developing devices 110 corresponding to toners of four colors including yellow, magenta, cyan and black (YMCK) to form a toner image without clear toner, on the intermediate transfer belt 141. For example, four charging rollers 121 of the image forming apparatus 100 respectively charge four photosensitive drums 120 corresponding to the four colors of toner, and four corresponding exposure units (or devices 130) form electrostatic latent images on the four photosensitive drums 120, respectively, in accordance with corresponding image data. Developing devices 110 of the example image forming apparatus 100 develops the respective electrostatic latent images on the four photosensitive drums 120 by forming toner images. The primary transfer rollers 145 of the image forming apparatus 100 cause the toner images formed on the four photosensitive drums 120, to be transferred onto the intermediate transfer belt 141 in sequence, so that they are combined and layered to form a single composite toner image on the intermediate transfer belt 141. According to examples, the print medium P is fed from the print medium conveying unit 170 to the transfer device 140, so as to transfer the toner image without clear toner, from the intermediate transfer belt 141 to the print medium P via the secondary transfer roller 146.

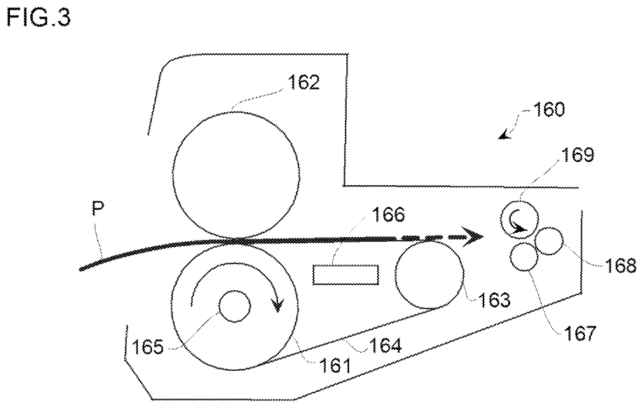

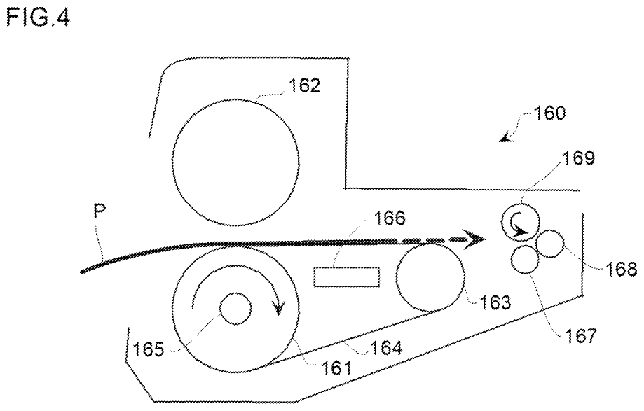

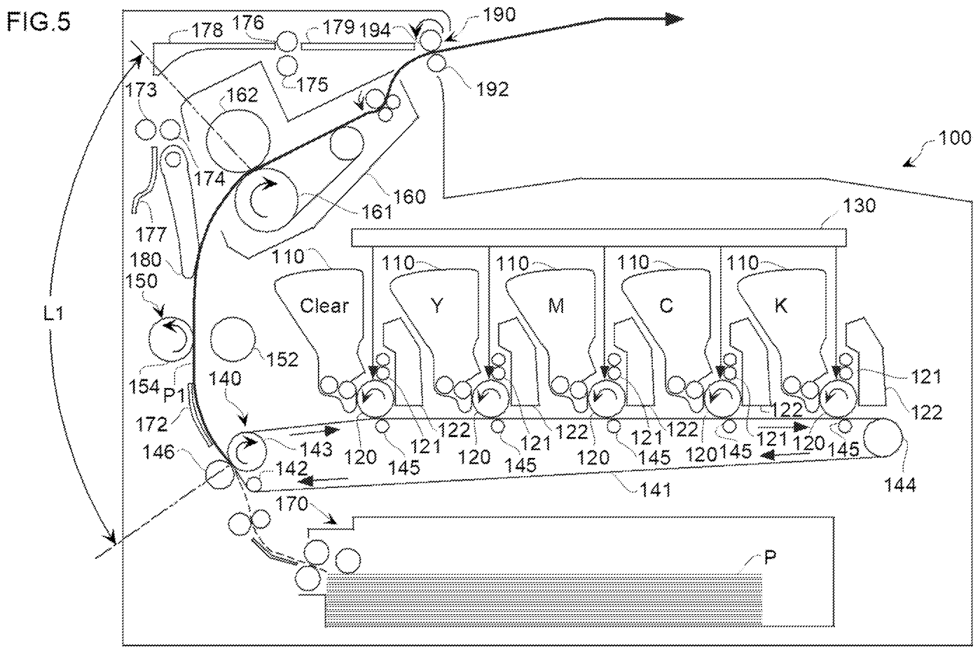

When a non-gloss image is to be formed, the image forming apparatus 100, for use of the fixing device 150, may bring the fixing roller 152 and the pressure roller 154 in contact with each other as shown in FIG. 1, so as to switch the fixing device 150 to an operating state (for example, by operating a heater and a driving device of the pressure roller 154). In addition, the conveyance path switching device 180 is moved to a rotational position (bypassing position) as shown in FIG. 1 in order to bypass the gloss applying device 160. Consequently, the fixing device 150 receives the print medium P having a toner image without clear toner from the transfer device 140, and uses the fixing roller 152 and the pressure roller 154 to apply heat and pressure, in order to fix (fuse and fix) the toner image to the print medium P. The conveying rollers 173, 174, 175, 176 convey the print medium P, to which the toner image without clear toner has been fixed, along guide plates 177, 178, 179, to the discharge device 190. Accordingly, the print medium P is conveyed to the discharge device 190 without passing through (by bypassing) the gloss applying device 160, and further discharged from the image forming apparatus 100 via discharge rollers 192, 194, so as to prevent or inhibit abrasion of the belt of the gloss applying device 160. In another example, the gloss applying device 160 may have a release/contact mechanism similar to the release/contact mechanism A shown in FIGS. 2A and 2B, as a release/contact mechanism between the heating roller 161 and the pressure roller 162. In this case, the gloss applying device 160 is set (or switched) in a non-operating state, the heating roller 161 and the pressure roller 162 are separated from each other as shown in FIG. 4, and the conveyance path switching device 180 is moved to a rotational position as illustrated in FIG. 5, to convey the print medium P to the discharge device 190 through the gloss applying device 160 being in a non-operating state. In this case, the gloss applying device is in a non-operating state, although the example of FIG. 5 illustrates an operating state. The gloss applying device 160 will be described further below with reference to FIG. 3.

FIG. 5 shows an example operation of the image forming apparatus 100 when a gloss image (also referred to as “high gloss image”) is to be formed. When a gloss image is to be formed, the image forming apparatus 100 first uses five developing devices 110 including a developing device 110 corresponding to clear toner to form a toner image including clear toner on the intermediate transfer belt 141. For example, the five photosensitive drums 120 are charged by the respective charging rollers 121, and are exposed to the respective exposure units 130 to form the electrostatic latent images in accordance with corresponding image data. The developing devices 110 develop the respective electrostatic latent images on the five photosensitive drums 120, forming toner images. The primary transfer rollers 145 cause the toner images that are formed on the five photosensitive drums 120, to be transferred onto the intermediate transfer belt 141 in sequence, so that they are combined and layered to form a single composite toner image on the intermediate transfer belt 141. The print medium P is conveyed from the print medium conveying unit 170 to the transfer device 140, and the secondary transfer roller 146 causes the toner image including clear toner to be transferred from the intermediate transfer belt 141 to the print medium P.

When a gloss image is to be formed, the image forming apparatus 100 switches the fixing device 150 to a non-operating state (for example, by stopping a heater, and a driving device of the pressure roller 154), so as to avoid using the fixing device 150, and as shown in FIG. 5, the fixing roller 152 and the pressure roller 154 are spaced apart from each other. In addition, the image forming apparatus 100 moves, the conveyance path switching device 180 to a rotational position as shown in FIG. 5 to use the gloss applying device 160. Consequently, the gloss applying device 160 can receive the print medium P having the clear toner-including toner image that has been conveyed from the transfer device 140 and has passed through the fixing device 150 which is in a non-operating state. The gloss applying device 160 can fix (fuse and fix) the toner image on the received print medium P to the print medium P by applying heat and pressure, and cool the fixed toner image. The cooled print medium P is sent toward the discharge device 190, to be discharged from the image forming apparatus 100 by the discharge rollers 192, 194.

The above-described separation of the fixing roller 152 from the pressure roller 154 enables the print medium P to pass through the fixing device 150 in a non-operating state and to be conveyed from the transfer device 140 to the gloss applying device 160, thereby avoiding the occurrence of a jam of the print medium P in the fixing device 150. In addition, as will be described below with reference to FIG. 3, the gloss applying device 160 has a greater release ability or release property than the fixing device 150. Thus, the image forming apparatus 100 fixes the toner image including clear toner by the gloss applying device 160, thereby preventing the print medium P from being jammed.

The fixing roller 152 and the pressure roller 154 are separated from each other as described above, and thereby, a conveyance path P1 is formed therebetween for conveying the print medium P from the transfer device 140 to the gloss applying device 160. The conveyance path P1 may be configured to prevent or inhibit a surface of the print medium P having a toner image (also referred to as “image surface”) to be in contact with any component of the image forming apparatus 100 when the print medium P is conveyed from the transfer device 140 to the gloss applying device 160. This can be achieved, for example, by supporting, along the conveyance path P1, the print medium P to be conveyed from the transfer device 140 to the gloss applying device 160 by contacting a side of the print medium P that is opposite to the image surface (e.g., from a surface on the side of the print medium P having no toner image) by use of various components of the image forming apparatus 100 during the conveyance thereof. Accordingly, the position or angle of a component to be used may be determined in accordance with the angle for discharging of the print medium P from the transfer device 140, so as to prevent or minimize contact with the image surface of the print medium P during conveyance thereof, to achieve a better quality of the formation of images.

With reference to FIG. 5, the example image forming apparatus 100 includes a guide plate 172 disposed between the transfer device 140 and the fixing device 150. The guide plate 172, the pressure roller 154 and the conveyance path switching device 180 support the print medium P to be conveyed from the transfer device 140 to the gloss applying device 160, along the conveyance path P1, from the side of the print medium P having no toner image. Accordingly, the positions or angles of the guide plate 172, the pressure roller 154 and the conveyance path switching device 180 are determined and set in accordance with the angle for discharging of the print medium P from the transfer device 140. In the example of FIG. 5, the print medium P is conveyed from the transfer device 140 to the gloss applying device 160 while being curved toward one side (side of the image surface) of the print medium P.

In order to assist conveyance of the print medium P along the conveyance path P1, the image forming apparatus 100 may include a star wheel. A star wheel makes contact with the print medium P exclusive through tips (tip ends) of a star and can support the print medium P in a state that is substantially a non-contact state. Accordingly, even when a star wheel is disposed at the side of the image surface of the print medium P, the star wheel can support the print medium P during conveyance with minimal or negligible contact, without substantially affecting the image quality. In some examples, the image forming apparatus 100 may include an air suction device disposed opposite the image surface (at the side of the print medium P having no toner image) to suck or draw the print medium P. Accordingly, the print medium P during conveyance is pulled to a guide member such as the guide plate 172 while keeping the print medium P a non-contact (or substantially non-contact) state during its conveyance, then stabilizing the movement of the print medium P. With reference to FIGS. 2A and 2B, in order to separate the fixing roller 152 from the pressure roller 154, the fixing roller 152 alone may be moved. In other examples, the pressure roller 154 alone may be moved, or the fixing roller 152 and the pressure roller 154 may both be moved.

A length L1 of the conveyance path P1 from the transfer device 140 to the gloss applying device 160 may be shorter than a length of the print medium P in a conveyance direction of the print medium. When the length L1 has such a length, the print medium P can be conveyed from the transfer device 140 to the gloss applying device 160 even in a state where the fixing roller 152 and the pressure roller 154 (driving roller) are separated (spaced apart or moved apart) from each other.

With reference to FIG. 3, an example gloss applying device 160 includes a heating roller 161, a pressure roller 162, a suspension roller 163 and an endless belt 164. The heating roller 161 includes a heater 165 such as a halogen lamp therein and is rotated by a driving device in the direction indicated by an arrow. The suspension roller 163 is disposed at a given distance from the heating roller 161. The endless belt 164 is suspended or supported between the heating roller 161 and the suspension roller 163 and moves circularly by following the rotation of the heating roller 161. The pressure roller 162 is rotated by following the rotation of the heating roller 161 while pressing the print medium P toward the heating roller 161 through the endless belt 164 such that the image surface of the print medium P is directed to the heating roller 161. The toner image on the print medium P is fixed (fused and fixed, or re-molten and fixed) in a nip region between the heating roller 161 and the pressure roller 162 by applying heat and pressure. The print medium P is then conveyed by the endless belt 164 from the heating roller 161 toward the suspension roller 163, and during conveyance, the toner image on the print medium P is cooled and solidified in such a state as to be close contact (in surface contact) with an outer circumferential surface of the endless belt 164, so as to generate the gloss image.

When the print medium P goes beyond the suspension roller 163, the flexural rigidity of the print medium P and the curvature of the suspension roller 163 cause the print medium P to be released from the endless belt 164 and sent out toward the discharge device 190 through conveyance rollers 167, 168, 169. The gloss applying device 160 cools and solidifies the toner image, to release the print medium P from the endless belt 164, and to prevent the print medium P from winding around the endless belt 164, so as to inhibit the occurrence of a jam of the print medium P. Accordingly, the gloss applying device 160 has higher release ability than the fixing device 150 which has no cooling function. In addition, the gloss applying device 160 can correct a curl of the print medium P by re-melting and cooling the toner image on the print medium P when it receives the print medium P having the curl formed thereon (due to the fixing device, for example) as will be described below with reference to FIG. 4.

In order to apply gloss to a toner image, the outer circumferential surface of the endless belt 164 may be formed of a highly releasable material such as a fluorine resin, and processed so as to have a mirror surface. Thus, in order to maintain the gloss applying function of the gloss applying device 160 over a long period, abrasion of the endless belt 164 should be avoided and the surface properties of the endless belt 164 should be maintained as long as possible. Accordingly, the image forming apparatus 100 may discharge the print medium P having a non-gloss image fixed at the fixing device 150, by bypassing the gloss applying device 160.

In order to enhance the cooling efficiency, the gloss applying device 160 may include a cooling device 166 such as a cooling duct disposed inside the endless belt 164. In some examples, the cooling device 166 may include a heat sink or a cooling fan. In some examples where sufficient cooling is available without a cooling device 166, the cooling device 166 may be omitted. In another example, the gloss applying device 160 may be configured such that the conveyance rollers 167, 168, 169 form a curl correction device in order to enhance the curl correction ability. The curl correction device may include three rollers.

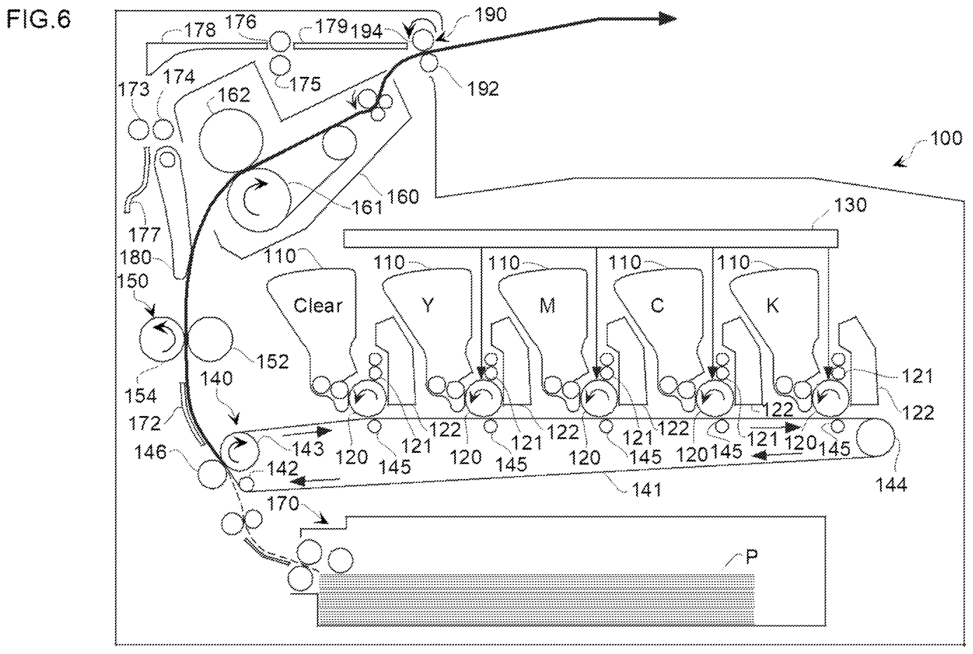

FIG. 6 shows an operation of the image forming apparatus 100 when a non-gloss image is to be formed under a predetermined condition. Even when a non-gloss image is to be formed, the image forming apparatus 100 may move the conveyance path switching device 180 to a rotational position as shown in FIG. 6, at a different position from the position illustrated in FIG. 1, under a predetermined condition, for use of the gloss applying device 160. This enables the image forming apparatus 100 to discharge the print medium P having fixed thereon a toner image without clear toner further through the gloss applying device 160. Under a predetermined condition which is unfavorable, such as hot and/or humid surroundings, even when a toner image does not include clear toner, the print medium P may not be easily released well from the fixing roller 152 at the fixing device 150, and although no paper jam is caused, a curl may be formed in the print medium P. The gloss applying device 160 can correct such a curl formed in the print medium P by the fixing device 150 by re-melting and cooling the toner image.

Regarding the above predetermined condition, the image forming apparatus 100 may move the conveyance path switching device 180 to a rotational position as shown in FIG. 6 when at least one of the following conditions is satisfied: (1) a deposition amount of toner per unit area (also referred to as “TMA” (toner mass per area)) on the print medium P is a certain amount or more (for example, 0.7 g/cm² or more); (2) a thickness of the print medium P is a certain level or less (for example, 60 μm or less); (3) an ambient temperature of the image forming apparatus 100 is a certain level or more (for example, 30° C. or higher); (4) an ambient humidity of the image forming apparatus 100 is a certain level or higher (for example, 85% or higher); and (5) a width of a head margin in the print medium P is a certain level or less (for example, 3 mm or less). The deposition amount of toner may be obtained by calculation from image data to be printed and may be detected by a photosensor or the like from the print medium P before the fixing operation. The width of a head margin in the print medium P may be obtained by a calculation from image data to be printed, and may be detected by a photosensor or the like from the print medium P before the fixing operation. The image forming apparatus 100 may include a sensor to detect a temperature or a humidity, and a sensor to detect a toner deposition amount on the print medium P or a width of a head margin in the print medium P.

In the examples described above with reference to FIGS. 1, 5 and 6, the image forming apparatus 100 may include a first switching device and/or a second switching device. The first switching device may switch between operational modes of the image forming apparatus 100 associated with the fixing device 150, depending whether or not an unfixed toner image is to be fixed by the fixing device 150 The second switching device may switch between operational modes of the image forming apparatus 100 associated with the gloss applying device 160, depending whether or not the gloss applying device 160 the toner image (either the unfixed toner image or the toner image fixed by the fixing device 150) is to be fixed by the gloss applying device 160. The first switching device may include a release/contact mechanism A to cause the fixing roller 152 (or the conveyance device, e.g., a fixing belt) and the pressure roller 154 (or the pressure device e.g., a pressure belt) to be separated from each other, or in contact with each other in the fixing device 150. The second switching device may include the conveyance path switching device 180, or a release/contact mechanism similar to the release/contact mechanism A illustrated in FIGS. 2A and 2B, that causes the heating roller 161 and the pressure roller 162 to be separated from or in contact with each other. The conveyance path switching device 180 is provided upstream of the gloss applying device 160 and may include a movable guide such as a movable guide plate to switch an advancing direction (or conveying direction) of the print medium P between a first advancing direction toward the gloss applying device 160 and a second advancing direction toward a bypass path (formed along the guide plates 177, 178, 179).

In the above-described example, on the assumption that clear toner has a higher adhesive force than other toner when it is fused by heat, the image forming apparatus 100 uses the first and second switching devices for switching of: use of the gloss applying device 160 exclusively, as shown in FIG. 5 to fix a toner image including clear toner; and use of both of the gloss applying device 160 and the fixing device 150 as shown in FIG. 6 to fix a toner image including color toner exclusively (e.g., a toner image including clear toner) when the above predetermined condition is satisfied. In other examples, toner (YMCK) other than clear toner may have a high adhesive force when it is fused by heat, and accordingly the image forming apparatus 100 may switch between the first and second switching devices such that a toner image is to be fixed by the gloss applying device 160 exclusively, when the above predetermined condition is satisfied, regardless of the kind of toner that forms a toner image (for example, regardless of whether or not clear toner is included). Although an example of a control of the first and second switching devices has been described herein, the first and second switching devices can be switched in various ways, according to other examples, depending on the various conditions.

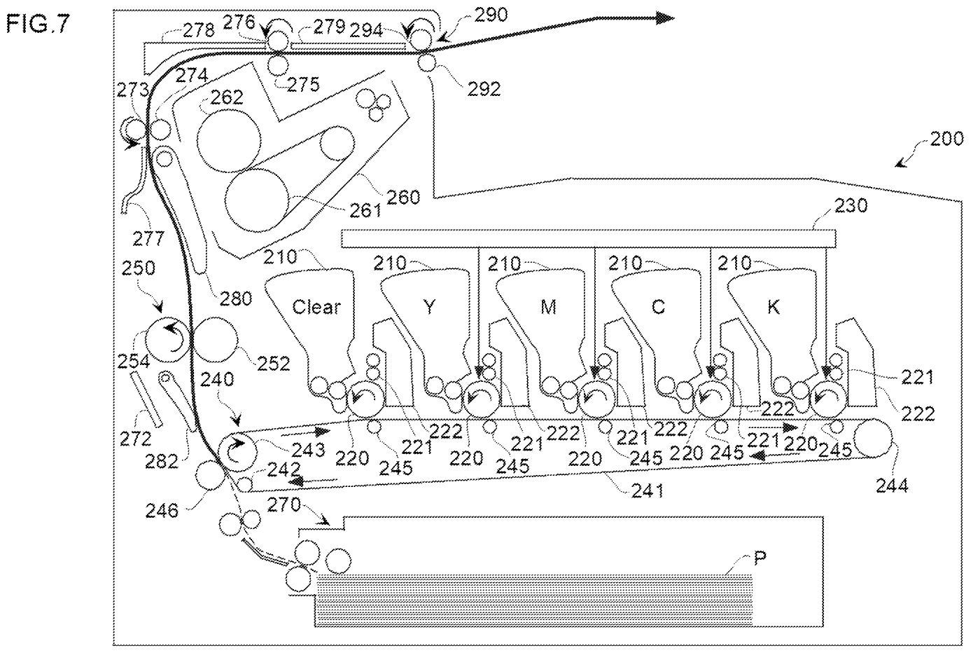

With reference to FIG. 7, another example image forming apparatus 200 includes a conveyance path switching device 282 for introducing a print medium P output from a transfer device 240 to a path, to bypass a fixing device 250. The conveyance path switching device 282 includes a guide plate rotatable about a rotational shaft, and the guide plate can be rotated by a driving device such as a solenoid. Reference numerals obtained by adding “100” to reference numerals of similar components of the image forming apparatus 100 are given to the components of the image forming apparatus 200.

FIG. 7 illustrates an example operation of the example image forming apparatus 200 when a non-gloss image is to be formed. When a non-gloss image is to be formed, the developing devices 210 corresponding to four colors (YMCK) of toner form a toner image without clear toner, on an intermediate transfer belt 241 in accordance with a similar procedure as described for the image forming apparatus 100 with reference to FIG. 1.

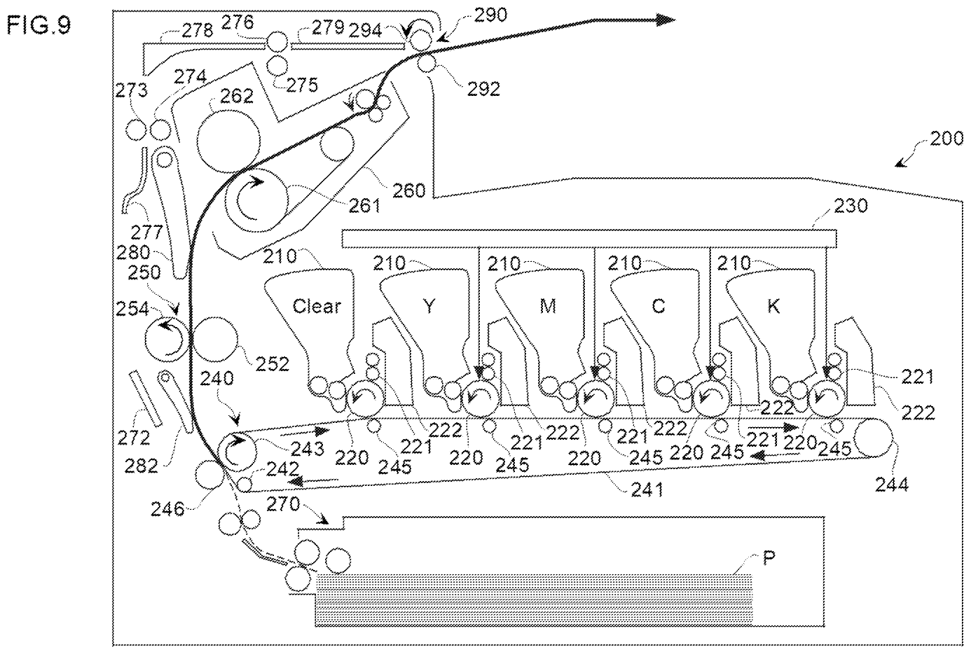

When a non-gloss image is to be formed, the fixing device 250 is switched to an operating state (for example, by operating a heater or a driving device of a pressure roller 254) so as be used in the operation of the image forming apparatus 200, the conveyance path switching device 282 is moved to a rotational position as shown in FIG. 7, and a fixing roller 252 and the pressure roller 254 are brought into contact with each other. In addition, in order to bypass a gloss applying device 260, the image forming apparatus 200 moves a conveyance path switching device 280 to a rotational position (“bypassing position”) as shown in FIG. 7. Consequently, the fixing device 250 receives the print medium P having a toner image without clear toner, from the transfer device 240, and the fixing roller 252 and the pressure roller 254 apply heat and pressure, thereby fixing (fusing and fixing) the toner image to the print medium P. Conveying rollers 273, 274, 275, 276 convey the print medium P, to which the toner image without clear toner has been fixed, along guide plates 277, 278, 279, to a discharge device 290. Accordingly, the print medium P may be conveyed to the discharge device 290 without passing or traveling through the gloss applying device 260 (e.g., bypassing the gloss applying device 260), to be discharged from the image forming apparatus 200 by discharge rollers 292, 294, so as to prevent or inhibit abrasion of the belt of the gloss applying device 260. In other examples, the gloss applying device 260 may include a release/contact mechanism similar to the release/contact mechanism A illustrated in FIGS. 2A and 2B, as a release/contact mechanism between the heating roller 261 and the pressure roller 262. In this case, the gloss applying device 260 is set in a non-operating state, the heating roller 261 is separated or spaced apart from the pressure roller 262 in a similar manner as described for the gloss applying device 160 with reference to FIG. 4, and the conveyance path switching device 280 is moved to the below-described rotational position as shown in FIG. 9, to convey the print medium P to the discharge device 290 by passing through the gloss applying device 260 that is in a non-operating state (although FIG. 9 illustrates the gloss applying device in an operating state).

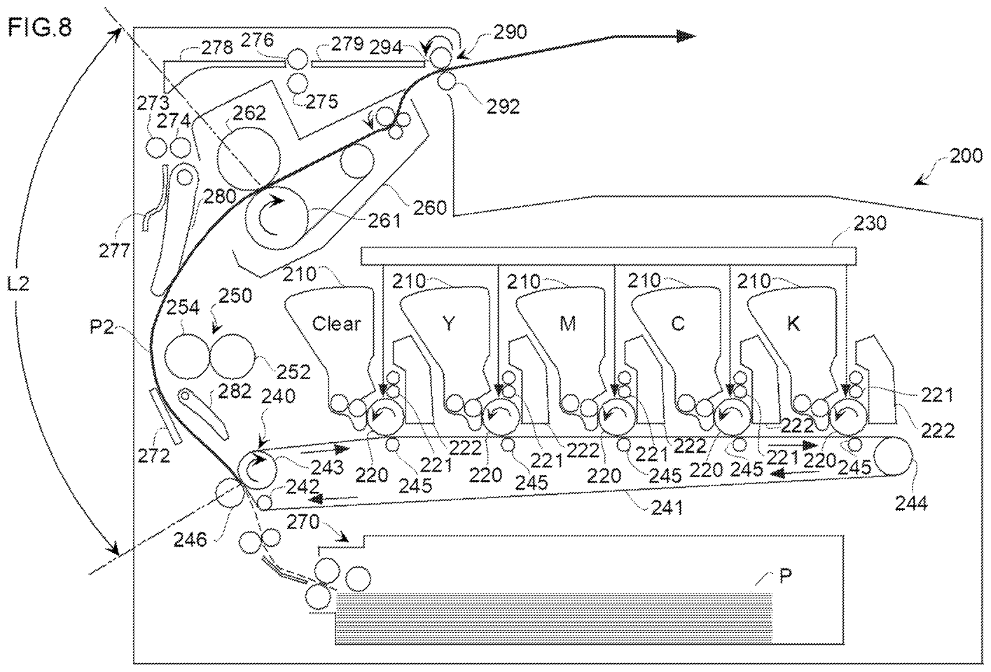

FIG. 8 shows an example operation of the image forming apparatus 200 when a gloss image is to be formed. When a gloss image is to be formed, the five developing devices 210 including a developing device 210 corresponding to clear toner, form a toner image including clear toner, on the intermediate transfer belt 241 in accordance with a similar procedure as described for the image forming apparatus 100 with reference to FIG. 5.

When a gloss image is to be formed, the fixing device 250 is switched to a non-operating state (for example, by stopping a heater, and a driving device of the pressure roller 254) so as not to be used in the operation, and the conveyance path switching device 282 is moved to a rotational position (“bypassing position”) as shown in FIG. 8. In addition, in order to use of the gloss applying device 260, the conveyance path switching device 280 is moved to a rotational position as shown in FIG. 8. Consequently, the print medium P having a toner image including clear toner that has been output from the transfer device 240, may be conveyed from the transfer device 240 to the gloss applying device 260 through a conveyance path P2 that does not go through (e.g., bypasses) the fixing device 250. The gloss applying device 260 can fix (fuse and fix) the toner image on the print medium P received from the transfer device 240, to the print medium P, by applying heat and pressure, and can cool the toner image. The cooled print medium P is sent toward the discharge device 290, and discharged from the image forming apparatus 200 by the discharge rollers 292, 294.

The example image forming apparatus 200 conveys the print medium P from the transfer device 240 to the gloss applying device 260 without going through the fixing device 250 as described above, thereby preventing or inhibiting the occurrence of a jam of the print medium P in the fixing device 250. In addition, as described above with reference to FIG. 3, the gloss applying device 260 has a higher release ability than the fixing device 250. Accordingly, the gloss applying device 260 fixes the toner image including clear toner, thereby preventing or inhibiting the occurrence of a jam of the print medium P.

In addition, the above-described moving of the conveyance path switching device 282 to the rotational position (“bypassing position”) as shown in FIG. 8 forms the conveyance path P2 for conveying the print medium P from the transfer device 240 to the gloss applying device 260 without passing through the fixing device 250. The conveyance path P2 may be configured so as to prevent or minimize a surface of the print medium P having a toner image (hereinafter, also referred to as “image surface”) from contacting any component of the image forming apparatus 200 when the print medium P is conveyed from the transfer device 240 to the gloss applying device 260. This can be achieved, for example, by supporting, along the conveyance path P2, the print medium P to be conveyed from the transfer device 240 to the gloss applying device 260 from the side of a surface of the print medium P having no toner image (the side of the print medium P that is opposite the image surface) by use of various components of the image forming apparatus 200 during conveyance thereof. Accordingly, the position or angle of a component to be used may be determined and set in accordance with the angle for discharging of the print medium P from the transfer device 240, so as to maintain the image surface of the print medium P in a non-contact state (or in a substantially non-contact state) during conveyance thereof, to maintain quality in the formation of images.

With reference to FIG. 8, the example image forming apparatus 200 includes a guide plate 272 disposed between the transfer device 240 and the conveyance path switching device 280. During conveyance along the conveyance path P2, the guide plate 272 and the conveyance path switching device 280 support the print medium P to be conveyed from the transfer device 240 to the gloss applying device 260 by engaging a side of the print medium P opposite the image surface (e.g., from the side of the surface of the print medium P having no toner image). Accordingly, the positions or angles of the guide plate 272 and the conveyance path switching device 280 are determined in accordance with the angle for discharging of the print medium P from the transfer device 240. In the example of FIG. 8, the print medium P is conveyed from the transfer device 240 to the gloss applying device 260 while being curved toward one side (side of the image surface) of the print medium P.

In order to assist conveyance of the print medium P along the conveyance path P2, the image forming apparatus 200 may include a star wheel forming a star (star shape), so as to contact the print medium P via tips of the star and support the print medium P in a state that is substantially a non-contact state (e.g., where the contact surface between the star wheel and the print medium P is negligible). Accordingly in some examples, the star wheel may be disposed on the side of an image surface of the print medium P so as to support the print medium P during conveyance substantially without affecting the image quality. In addition, according to examples, the image forming apparatus 200 may include an air suction device. An air suction device may be disposed at the side of the print medium P that is opposite the image surface side (e.g., the side of the print medium P having no toner image) to suck or draw the print medium P, so as to pull or draw the print medium P during conveyance toward a guide member such as the guide plate 272 while keeping the print medium P in a non-contact state during its conveyance, and to stabilize the movement of the print medium P.

A length L2 of the conveyance path P2 from the transfer device 240 to the gloss applying device 260 may be shorter than a length of the print medium P in conveyance direction, so as to convey the print medium P from the transfer device 240 to the gloss applying device 260 even when the print medium P does not go through (e.g., bypasses) the fixing device 250.

FIG. 9 shows an operation of the image forming apparatus 200 when a non-gloss image is to be formed under a predetermined condition. Even when a non-gloss image is to be formed, the image forming apparatus 200 may move the conveyance path switching device 280 to a rotational position as shown in FIG. 9, at a different position from the position in the example of FIG. 7, under a predetermined condition, to convey the print medium P to the gloss applying device 260 so as to use the gloss applying device 260. Accordingly, the print medium P having a toner image without clear toner fixed thereto, is discharged through the gloss applying device 260. Under a predetermined condition (e.g., unfavorable condition) such as hot and humid surroundings, even without any clear toner in the toner image, the fixing roller 252 of the fixing device 250 may be inhibited from releasing the print medium P smoothly, and even without any jam occurring, a curl may form in the print medium P. The fixing device 250 of the gloss applying device 260 can correct such a curl formed in the print medium P by re-melting and cooling the toner image.

Regarding the above predetermined condition, the image forming apparatus 200 may move the conveyance path switching device 280 to a rotational position as shown in FIG. 9 when at least one of the following condition is satisfied: (1) a deposition amount of toner per unit area (also referred to as “TMA” (toner mass per area)) on the print medium P is a certain amount or more (for example, 0.7 g/cm² or more), (2) a thickness of the print medium P is a certain level or less (for example, 60 μm or less), (3) an ambient temperature of the image forming apparatus 200 is a certain level or more (for example, 30° C. or higher), (4) an ambient humidity of the image forming apparatus 200 is a certain level or higher (for example, 85% or higher), and (5) a width of a head margin in the print medium P is a certain level or less (for example, 3 mm or less). The deposition amount of toner may be obtained by calculation from image data to be printed and may be detected by a photosensor or the like from the print medium P before the fixing. The width of a head margin in the print medium P may be obtained by calculation from image data to be printed and may be detected by a photosensor or the like from the print medium P before the fixing. The image forming apparatus 200 may include a sensor to detect a temperature or a humidity, and a sensor to detect a toner deposition amount on the print medium P or a width of a head margin in the print medium P. Other may be similar to features of the example shown in FIG. 5.

In the examples described-above with reference to FIGS. 7, 8 and 9, the image forming apparatus 200 may include the conveyance path switching device 282 as a first switching device to switches between conveyance paths depending on whether or not an unfixed toner image is to be fixed by the fixing device 250. The conveyance path switching device 282 is provided upstream of the fixing device 250 and it may include a movable guide such as a movable guide plate to switch an advancing direction of the print medium P between a first advancing direction toward the fixing device 250 and a second advancing direction toward a bypass path (formed along the guide plate 272). In addition, the image forming apparatus 200 may include a second switching device. In some examples, the second switching device includes the conveyance path switching device 280 to switch between conveyance paths depending on whether or not the gloss applying device 260 is to fix the unfixed toner image or the toner image having been fixed by the fixing device 250. In other examples, the second switching device includes a release/contact mechanism that may be similar to the release/contact mechanism A described with reference FIGS. 2A and 2B to cause the heating roller 261 to be spaced apart or in contact with the pressure roller 262. The conveyance path switching device 280 is provided upstream of the gloss applying device 260, and may include a movable guide such as a movable guide plate to switch advancing directions of the print medium P between a first advancing direction toward the gloss applying device 260 and a second advancing direction toward a bypass path (formed along the guide plates 277, 278, 279).

In the above-described example, on the assumption that clear toner has a higher adhesive force than other toner when it is fused by heat, the image forming apparatus 200 has used the first and second switching devices for switching between a first operational mode so as to use the gloss applying device 260 exclusively, as described with reference to FIG. 8 to fix a toner image including clear toner, and a second operational mode so as to use both the gloss applying device 260 and the fixing device 250 as described with reference to FIG. 9 to fix a toner image including color toner exclusively (e.g., a toner image without clear toner) when the above predetermined condition is satisfied. However, in another example, color toner (YMCK) (e.g., toner other than clear toner) may have an increased adhesion (e.g., adhesive force) when it is fused by heat, and therefore the image forming apparatus 200 may switch between the first and second switching devices such that a toner image is to be fixed by use of the gloss applying device 260 exclusively when the above predetermined condition is satisfied, regardless of the kind of toner forming a toner image (for example, regardless of whether or not clear toner is included). Although examples of the control of the first and second switching devices have been described, the first and second switching devices can be operated in various ways depending on the various conditions.

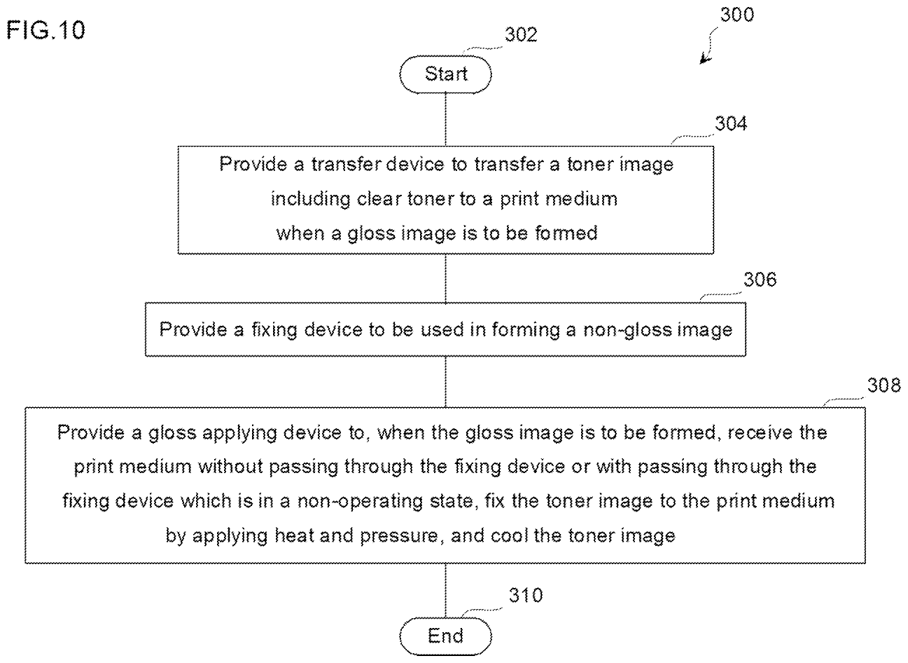

FIG. 10 illustrates a flow chart of an example method 300 of manufacturing an example image forming apparatus in which a toner image is fixed using a gloss applying device. The example manufacturing method 300 starts (302) and provides a transfer device for transferring a toner image including clear toner on a print medium when a gloss image is to be formed (304). The manufacturing method provides a fixing device to be used when a non-gloss image is to be formed (306). The manufacturing method provides a gloss applying device to receive, when the gloss image is to be formed, the print medium without passing through the fixing device or with passing through the fixing device which is in a non-operating state, fix the toner image to the print medium by applying heat and pressure, and cool the toner image (308) before ending (310).

It is to be understood that not all aspects, advantages and features described herein may necessarily be achieved by, or included in, any one particular example. Indeed, having described and illustrated various examples herein, it should be apparent that other examples may be modified in arrangement and detail is omitted.

1. An image forming apparatus comprising:
a transfer device to transfer an unfixed toner image including clear toner to a print medium, wherein the clear toner is associated with a gloss image to be formed;
a fixing device located along a conveyance path of the print medium; and
a gloss applying device to receive the print medium including the unfixed toner image, the gloss applying device to fix the unfixed toner image to the print medium by applying heat and pressure to form a heated toner image, and to cool the heated toner image to form the gloss image.

2. The image forming apparatus according to claim 1,
wherein the fixing device is to be set in a non-operating state when the gloss image is to be formed, to convey the print medium having the unfixed toner from the transfer device to the gloss applying device.

3. The image forming apparatus according to claim 2,
wherein the fixing device includes a conveying device and a pressure device, wherein the fixing device is selectively operable to be set in an operating state wherein the conveying device is in contact with the pressure device to fix a non-gloss image, and to be set in the non-operating state wherein the conveying device is spaced apart from the pressure device to avoid fixing the unfixed toner image that includes the clear toner.

4. The image forming apparatus according to claim 3, wherein a conveyance path extending between the transfer device and the gloss applying device is formed to be substantially free of contact with the unfixed toner image on the print medium.

5. The image forming apparatus according to claim 3, wherein a length of the conveyance path from the transfer device to the gloss applying device is shorter than a length of the print medium in a conveyance direction of the conveyance path.

6. The image forming apparatus according to claim 1,
wherein the conveyance path forms a first conveyance path to convey the print medium through the fixing device, and
wherein the image forming apparatus comprises:
a second conveyance path that extends from the transfer device to the gloss applying device and that bypasses the fixing device; and
a conveyance path switching device to direct the print medium to the second conveyance path when the gloss image is to be formed.

7. The image forming apparatus according to claim 6, wherein the second conveyance path is formed to be substantially free of contact with the unfixed toner image on the print medium.

8. The image forming apparatus according to claim 6, wherein a length of the second conveyance path from the transfer device to the gloss applying device is shorter than a length of the print medium in a conveyance direction of the second conveyance path.

9. The image forming apparatus according to claim 1,
the transfer device to transfer a color toner image without clear toner to a print medium,
the fixing device to fix the color toner image to the print medium by applying heat and pressure to form a fixed toner image, and
the gloss applying device to correct a curl formed in the print medium, under a predetermined condition, by re-melting and cooling the fixed toner image.

10. The image forming apparatus according to claim 9, wherein the predetermined condition includes at least one condition selected from the group consisting of: conditions associated with a deposition amount of toner per unit area on the print medium, a thickness of the print medium, an ambient temperature in the image forming apparatus, an ambient humidity in the image forming apparatus, and a width of a head margin in the print medium.

11. The image forming apparatus according to claim 1, wherein the gloss applying device includes:
a heating roller including a heater;
a suspension roller;
an endless belt engaging the heating roller and the suspension roller to move circularly; and
a pressure roller to press the print medium on the endless belt against the heating roller, to fix the toner image through heat and pressure,
the endless belt to engage the toner image in surface contact when the toner image having been fixed is cooled.

12. The image forming apparatus according to claim 11, wherein the gloss applying device includes a cooling device located within the endless belt.

13. An image forming apparatus comprising:
a transfer device to transfer a toner image to a print medium;
a fixing device to fuse and fix the toner image by applying heat and pressure;
a gloss applying device to heat and press the toner image on the print medium to form a heated toner image, to cool the heated toner image while the heated toner image is in surface contact with a belt, and to release the print medium from the belt;
a first switching device to selectively operate the fixing device to fix the toner image on the print medium when the toner image is to be fixed by the fixing device; and
a second switching device to selectively operate the gloss applying device to fix the toner image on the print medium when the toner image is to be fixed by the gloss applying device.

14. The image forming apparatus of claim 13, wherein
wherein the fixing device includes a conveying device and a pressure device, and
wherein the first switching device includes at least one of:
a release-contact device to switch the fixing device between an operating state wherein the conveying device is in contact with the pressure device, and a non-operating state wherein the conveying device is spaced apart from the pressure device; and
a movable guide provided upstream of the fixing device in a conveyance direction of the print medium to switch a conveyance path of the print medium between a first conveyance path that extends through the fixing device and a second conveyance path that bypasses the fixing device.

15. The image forming apparatus of claim 13,
wherein the gloss applying device includes a heating roller and a pressure roller, and
wherein the second switching device includes at least one of:
a release-contact device to switch the gloss applying device between an operating state wherein the heating roller is in contact with the pressure roller, and a non-operating state wherein the heating roller is spaced apart from the pressure roller; and
a movable guide provided upstream of the gloss applying device in a conveyance direction of the print medium to switch a conveyance path of the print medium between a first conveyance path that extends through the gloss applying device and a second conveyance path that bypasses the gloss applying device.
